(19) United States
(12) Patent Application Publication
(10) Pub. No.: US 2020/0268177 A1
(43) Pub. Date: Aug. 27, 2020

(54) STAND AND METHOD TO PRODUCE IT

(71) Applicant: JO-BEND OY, Kestilä (FI)

(72) Inventor: Jorma Pääkkö, Kestilä (FI)

(21) Appl. No.: 16/759,524

(22) PCT Filed: Oct. 11, 2018
(86) PCT No.: PCT/FI2018/050733

§ 371 Date: Apr. 27, 2020

(30) Foreign Application Priority Data
Oct. 30, 2017 (FI) U20174245

(51) Int. Cl. A47F 5/08; A47B 73/00; A47F 5/16; A47F 7/28; A47G 23/02; B21D 53/36; B25H 5/00; A47J 47/16

(52) U.S. Cl. CPC A47F 5/0876; A47B 73/00; A47F 5/16; A47F 7/283; A47F 7/285; F21V 35/00; A47G 23/0266; B21D 53/36; B25H 5/00; A47J 47/16; A47F 2005/165; A47G 23/02

(57) ABSTRACT

The object of the invention is a stand for the vessels like bottles, cans. and/or boxes, which stand (10) consists of a board like body (1) that is upright or inclining and at least one first support part (5) to be adapted around the vessel (11). The object of the invention is also the method to produce the mentioned stand. The first support part (5) has been cut partly off the body (1) and attached to the body only by the second isthmus (4) and it is a ring like part of the body that can be bent or has been bent into a certain angle (α) in relation to the surface (1.5) of the body by bending the mentioned isthmus. The stand can also include a tumbler (1.4) that has been fixed to the down part of the opening (1.3) of the body and it is meant to support the bottom of the vessel (11). In an application of the invention the stand (10) comprises the second support part (6) that is meant to support the down part of the vessel (11) that is partly from the body loose cut and connected to the body only by the first isthmus (3) and it is a board like part of the body and it can be bent or has been bent into a certain angle (β) in relation to the surface (1.5) of the body by bending the mentioned isthmus.

### CROSS-REFERENCE TO RELATED APPLICATIONS

This is a U.S. national application filed under 35 U.S.C. 371 which is based on international application no. PCT/FI2018/050733 filed Oct. 11, 2018, which claims priority to FI application no. U20174245 filed Oct. 30, 2017 and are incorporated herein by reference.

### BACKGROUND AND BRIEF SUMMARY OF THE INVENTION

The object of this invention is a stand for objects and vessels and it consists of an upright or an inclined position meant flat body and at least one support part around the object or vessel. The object of the invention is also the method to produce the mentioned stand.

The objects that are suitable to be used with the invention are for instance candles, torches to be burned, electric or hand tools, and suitable vessels are for instance different fluid, powder, spray/aerosol bottles and cans, jars and cases.

The invention is used for the usage, storage and presentation of the mentioned objects and vessels. A favorable usage location of the invention is a wall. The invention is especially suitable to be used with objects like bottles, cans and other similar shape objects. It is also suitable to be used with cone objects. The bottles and the cans can be stored in the stand according to the invention for a longer or shorter time. With the invention the objects can be presented well for usage or sale.

The stands for the bottles, cans and the boxes for the before mentioned purpose are mainly horizontal shelves. It is also known to fix certain stands to walls for the storage of the objects.

The patent publication U.S. Pat. No. 4,365,720 presents a stand to be fixed to the wall. In FIG. 1, two jars have been fixed to an inclined surface stand in such a way that about a half of the volume of the jars has been embedded sideways to the openings of the stand.

The patent publication FR 2 582 207 presents an inclined stand that is standing on its own foot. To the body of the stand it has been fixed one upon other tumblers with holes in the same line so that an object can be placed to the holes of the tumblers so that the object gets support from the sides of the hole. This kind of object is a stick in FIG. 5.

In the publication DE 270 7552 there has been presented a stand with a case like body. There has been made a hole to the front wall of the body and in the FIG. 4 an object (screw driver) has been placed to the hole so that the down end of the object leans against the back wall of the body and the object is supported in an inclined position.

The greatest disadvantages of the known technology stands for storage and presentation of the bottles, jars and boxes are in their production methods and costs. About the publications that have been mentioned before the technique of the French publication FR 2 582 207 could be adopted for instance to the storage of the bottles and cans if the size of the holes of the tumblers would be suitable for them. The disadvantage of this solution is the relatively high production costs caused by the relatively complicated production process. The stand consists of a number of parts that have been joined together. Another disadvantage is that this kind of a 3D product requires a big package and its handling, transportation and storage costs are high.

The intention of this invention is to achieve such a stand that avoids the drawbacks of the known technique. It is characteristic for the solution according to the invention to achieve what has been presented in the characterizing parts of the claims 1 and 9.

The greatest advantages of the invention relate to the production process and the handling of the present stand. The production and getting in the usage state of the stand according to the invention demand minimum only two stages. The stand according to the invention can be packed into a small flat package, so that the handling, storage and transportation costs of the package remain considerably lower that with the corresponding products of the known technology for the same purpose.

One advantage of the invention is that when using it the objects are well displayed. The objects are at different levels and thus the problem of poor accessibility of the objects at the same level does not exist.

In this document, the term “wall” means all the essentially upright and inclined constructions like for instance wall, partitions, doors, vehicle walls and panels etc.

### BRIEF DESCRIPTION OF THE DRAWINGS

The invention is described in more detail in the enclosed drawings where:

FIG. 1 is a planar view drawing of the stand of the present invention before bending its support parts.

FIG. 2 is a perspective view drawing of the stand of the present invention.

FIG. 3 is a drawing of a cut made to the body of the stand.

FIG. 4 is a front planar view drawing of the stand of the present invention after the support parts have been bent.

FIG. 5 is a perspective view of the stand illustrated in FIG. 4 herein.

FIG. 6 is a front planar view drawing of the stand of the present invention in use.

FIG. 7 is a side view drawing of the stand of the present invention in use.

FIG. 8(a) is a drawing of an alternative cut made to the body of the stand of the present invention and FIG. 8(b) is a side view drawing of the alternative cut made to the body of the stand of the present invention of FIG. 8(s) shown in use.

FIG. 9 is a drawing of an alternative table and floor embodiment of the stand of the present invention.

FIG. 10 is a drawing of yet another alternative embodiment of the stand of the present invention.

### DETAILED DESCRIPTION OF THE INVENTION

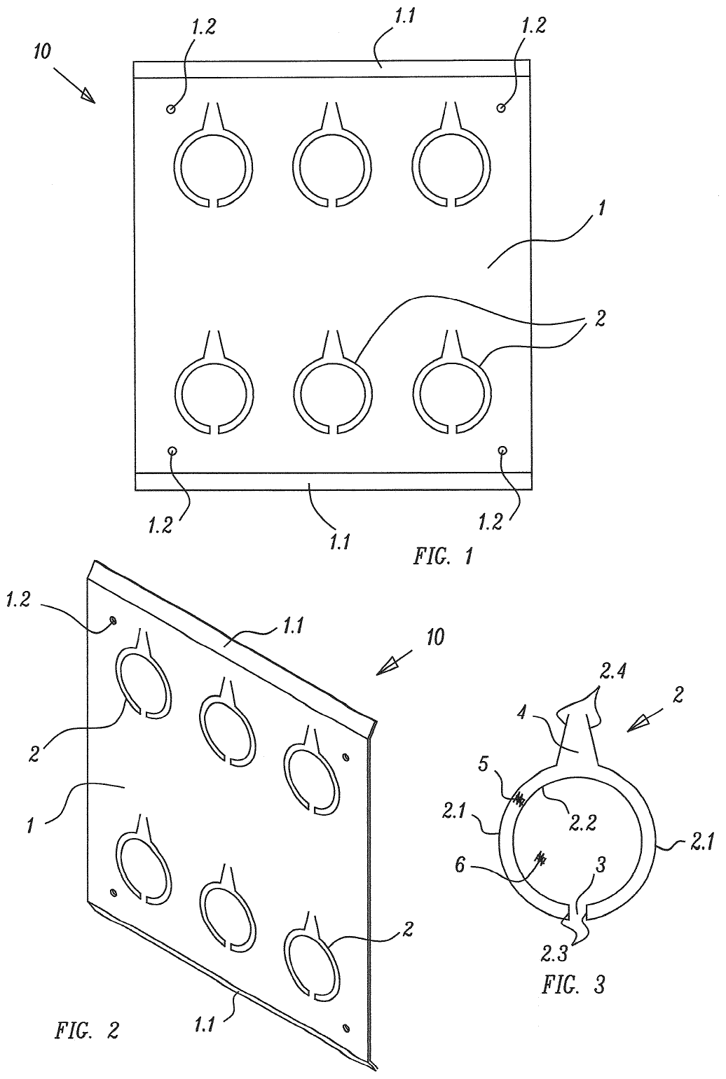

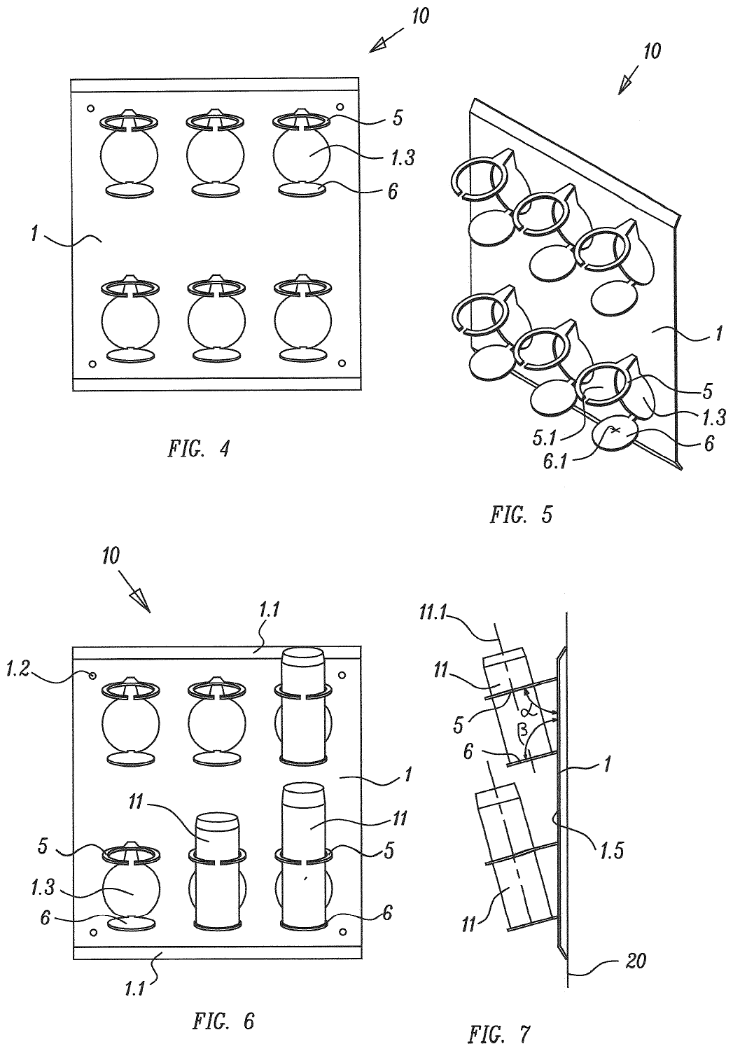

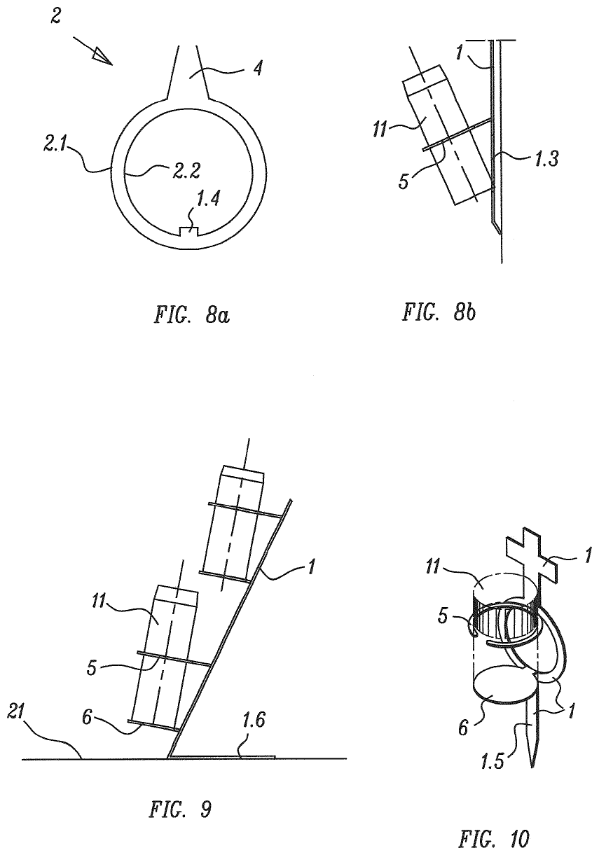

FIG. 1 presents a stand according to the invention before bending its support parts; FIG. 2 presents the before mentioned stand in 3D; FIG. 3 presents more closely a cut made to the body of the stand; FIG. 4 presents the stand after the support parts have been bent seen directly from the front; FIG. 5 presents the before mentioned stand in 3D; FIGS. 6 and 7 present the before mentioned stand in use; FIG. 8a presents one other technique of the cut of the invention; FIG. 8b presents a solution of the invention coming out of the mentioned cut; FIG. 9 presents a table and floor solution of the invention; FIG. 10 presents a solution that differs from the previous ones.

Next a construction and operation of a favorable solution is described referring to the before mentioned figures.

In FIGS. 1 and 2 there has been shown a stand 10 according to the invention in a situation where the support organs supporting the vessels to be put in it have not yet been bent into their final position. The stand 10 has been placed in the figures upright that is its usage position. The stand has a board like body 1 and the stand of this example has six similar cuts 2. The cut that has been presented zoomed in FIG. 3 goes all the way through the body and it consists of the first ring 2.1 and the second ring 2.2. The mentioned rings are a bit less than whole rings and they have been joined in the down end into each other with the third parts 2.3 of the mentioned cuts so that there will be left between them the first isthmus 3. The outer that is the first ring 2.1 is of two parts and at its top end between the parts of these ends is the other isthmus 4. The second isthmus 4 has been continued upwards with the fourth parts 2.4 of the upwards continued cuts 2 of the ends of the first ring 2.1. Between the first ring 2.1, the second ring 2.2 and the third parts 2.4 of the cuts there is the round first support part 5 that is fixed to the other body by the second isthmus 4. Inside the inner second ring 2.2 there is the second support part 6 that is fixed to the other body by the first isthmus 3. On two sides of the body 1, in this example on the top and the down edge, there are the bending 1.1 and there have been made fixing holes 1.2 to the body to fix it to the wall. The before mentioned stand 10 is ready to be packaged and transported to its usage location.

In FIGS. 4-7 there has been described the stand 10 according to the invention ready to be used and fixed to the wall 20 through holes 1.2 and in use. The first support parts 5 have been turned upwards from the level of the body 1 in certain angle a to the surface 1.5 of the body. The second support parts 6 have been bent downwards from the surface of the body into such an angle 13 to the surface 1.5 of the body in such a way that the mentioned support parts are essentially parallel. The cut 2 has been formed so that the bottom of the vessel 11 inside the first support part 5 comes upon the second support part 6. The first support part 5 has been bent by bending the second isthmus 4 and the second support part 6 has been bent by bending the first isthmus 3. The bending 1.1 of the body sides set the body 2 upright part loose from the wall 20 so the lids of the bottles and the jars can be kept in the openings of the body. The stand according to the invention can also be realized without bending 1.1.

According to the FIG. 7 the vessels 11 have been settled to the stand 10 in inclined position in relation to the body. With favorable shape of the cut 2 and favorable bending angles α and β it is possible to get a situation where the length axis 11.1 of the vessel 11 that has been put to the opening 5.1 of the first support part 5 is essentially located in the middle 6.1 of the second support part 6.

The stand 10 according to the invention can also be realized so that there is not the second support part 6 in one or more vessel location. In such a case, the second ring 2.2 of the cut 2 is made a closed ring and its inside part is removed. The bottom of the vessel 11 can in this case be supported to the opening 1.3 of the body. In FIG. 8a there has been presented the cut 2 to be made in this kind of solution of the invention and in the FIG. 8b there has been presented a setting where the vessel 11 has been put into this kind of stand 10. It is possible to get additional support for the bottom of the vessel 11 by adapting a twist to the down part (in usage position) of the second ring 2.2 that produces a tumbler 1.4 directing to the body forming opening 1.3.

The material of the stand according to the invention is metal, plastic, or some other material that does not break when bending the isthmuses 3, 4 and that the support parts 5, 6 are able to retain their positions after bending. The wall thickness of the body 1 is selected so that the bending can be made in the desired way either by hand or using a certain tool.

The stands 10 can be produced for the vessels 11. The support parts 5, 6 can be formed according to the vessels 11 that are used either curved or angular and their distance from each other can be regulated according to the vessel heights that are kept in the stand. The vessel amount in a stand can be selected freely and they can be placed in many ways. One favorable way for the vessel layout is to form between the superimposed vessel location rows sideways steps so that the surface of the body is used more efficiently.

As we know the shape of the vessels 11 to be used in the stand 10 the cuts 2 can be designed and realized favorably for them.

The stand 10 can also be realized so that the surface 1.5 of the body is inclined in relation to upright position when it is in its usage position. When the stand is fixed to an upright wall this can be realized for example so that the bending 1.1 of the upper part of the body is more/less or steeper/gentler than the down part bending.

The stand 10 according to the invention can also be realized as a table or floor stand. In that case there will be adapted a table or floor foot. According to the FIG. 9 principle the foot part or foot can be realized for instance as a bending 1.6 of the down part of the body 1 and the bend is adapted according to the base 21 in the surface of the table or the floor direction. It is possible to make to the bending place something that renders the bending easier, e.g. auxiliary cuts.

In FIG. 10 there has been described a solution of the invention that is different from the previous ones: a stand for the grave candles. The sharp down part to be pushed to the earth and a cross shape upper part forming body 1 is essentially upright and the first support part 5 and the second support part 6 have both been turned 90° to the surface 1.5 of the body and the object 11 that in this example is a grave candle has thus been put essentially upright. In this example the cross can also be replaced by half moon.

The body 1 can be shaped by its outer edges in all cases according to the usage of the stand. It is central for the invention that in spite of the shape of the outer edges the body 1 is always flat and that the cut/s 2 produce at least one first support part 5 that is still a part of the mentioned body. So the stand 10 is as a whole of one and same piece.

The stand 10 can be adapted very largely to be used with different kinds of objects and vessels 11. The stand can also be shaped for many such objects and vessels that have not been mentioned separately in this document.

The cuts 2 can be made in the method according to the invention most favorably by laser or water cutting method. The method according to the invention is not limited to be realized only by these cutting methods, but the cuts can be made also by some other method like for instance a mechanical machining or any other usable method.

It is characteristic for the method according to the invention that the cuts can be made to the stand 10 in different locations than the bending of the support parts 5, 6. In this case the stand 10 can be transported from the production location to the usage place favorably in a flat board like package and it can be adapted to the usage state by bending the mentioned support parts and possibly also the foot part into the usage position.

It is possible to add to the transportation package of the stand 10 according to the invention instructions about the favorable bending angles α, β of the support parts 5, 6 so that the stand can be made quickly into the usage state.

It should be noticed that even though this description sticks to one for the invention favorable application example this does not want to limit the usage of the invention to only this kind of application, instead, many variations are possible within the invention idea as presented in the claims.

1. (canceled)

2. (canceled)

3. (canceled)

4. (canceled)

5. (canceled)

6. (canceled)

7. (canceled)

8. (canceled)

9. (canceled)

10. A stand for objects and/or vessels, which stand consists of a flat board like body to be intended in an upright or inclined position and at least one partly off the body cut reaching through the mentioned body cut meant to be put round the object or vessel circle first support organ and meant to be the lower second plate like support of the object or the vessel characterized in that:
a. the first support part has been connected to the body by the second isthmus and the second support part has been connected to the body by the first isthmus,
b. the first and the second support parts have been formed with one cut that consists of the first circle, the second circle, the third parts, and the fourth parts one after the other,
c. the first support part has been formed essentially between the mentioned cut first circle and second circle,
d. the second support part has been formed inside the mentioned cut second circle,
e. the first support part has been put to be bent into a certain angle in relation to the body surface by bending the second isthmus and the second support part has been put to be bent into a certain angle in relation to the body surface by bending the first isthmus.

11. The stand according to the claim 1 characterized in that the first support part and/or the second support part has been adapted essentially in an upright position in relation to the length axis of the vessel that has been or will be placed resting on them.

12. The stand according to claim 1 characterized in that it consists fixing holes or other fixing organs to fix it to the wall.

13. The stand according to claim 2 characterized in that it consists fixing holes or other fixing organs to fix it to the wall.

14. The stand according to claim 1 characterized in that it consists the bending made to the body to keep the surface at a certain distance off the wall.

15. The stand according to claim 2 characterized in that it consists the bending made to the body to keep the surface at a certain distance off the wall.

16. The stand according to claim 3 characterized in that it consists the bending made to the body to keep the surface at a certain distance off the wall.

17. The stand according to claim 1 characterized in that it consists of a foot to put the stand upon a platform like a table or a floor.

18. The stand according to claim 2 characterized in that it consists of a foot to put the stand upon a platform like a table or a floor.

19. The stand according to claim 1 characterized in that it has been adapted to be used with a candle, a torch to be burned, a hand or electric tool, a bottle of fluid, powder, spray aerosol, a jar or a box or with a number of the mentioned.

20. The stand according to claim 2 characterized in that it has been adapted to be used with a candle, a torch to be burned, a hand or electric tool, a bottle of fluid, powder, spray aerosol, a jar or a box or with a number of the mentioned.

21. The stand according to claim 3 characterized in that it has been adapted to be used with a candle, a torch to be burned, a hand or electric tool, a bottle of fluid, powder, spray aerosol, a jar or a box or with a number of the mentioned.

22. The stand according to claim 4 characterized in that it has been adapted to be used with a candle, a torch to be burned, a hand or electric tool, a bottle of fluid, powder, spray aerosol, a jar or a box or with a number of the mentioned.

23. The stand according to claim 5 characterized in that it has been adapted to be used with a candle, a torch to be burned, a hand or electric tool, a bottle of fluid, powder, spray aerosol, a jar or a box or with a number of the mentioned.

24. A method to produce a stand that consists of the board like body and at least one partly off the body cut reaching through the mentioned body cut meant to be put round the object or vessel circle first support organ and meant to be the lower second plate like support of the object or the vessel characterized in that the mentioned stand is made as follows:
a. at least one cut is made to the body reaching through the body forming the first support part and the second support part so that the first support part that is a part of the body is kept connected to the body by the second isthmus that is between the ends of the mentioned cut and the second support part that is a part of the body is kept connected to the body by the first isthmus that is between the third parts of the mentioned cut,
b. the first and the second support parts are formed with one cut the parts of which are the first circle, the second circle, the third parts, and the fourth parts,
c. thus the first support part is formed essentially between the first circle and the second circle of the mentioned cut,
d. the second support part is thus formed inside the second circle of the mentioned cut,
e. at least one first support is bent into a certain angle in relation to the body surface by bending the second isthmus and at least one second support part is bend in relation to the body surface into a certain angle by bending the first isthmus.

25. The method according to the claim 24 characterized in that the cuts to the body are made by laser or water cutting method, a mechanical machining or by some other usable manner.

26. The method according to some of the claims 24 characterized in that the cuts are made in the production site of the stand and the bending of the mentioned support parts elsewhere.

27. The method according to some of the claims 25 characterized in that the cuts are made in the production site of the stand and the bending of the mentioned support parts elsewhere.
